(19) United States
(12) Patent Application Publication
(10) Pub. No.: US 2020/0409556 A1
(43) Pub. Date: Dec. 31, 2020

(54) ENHANCED CASCADED GLOBAL MIRROR

(71) Applicant: International Business Machines Corporation, Armonk, NY (US)

(72) Inventors: JASON L. PEIPELMAN, TRAVIS, TX (US); MATTHEW J. WARD, VAIL, AZ (US); Paul Jennas, TUCSON, AZ (US)

(21) Appl. No.: 16/451,354

(22) Filed: Jun. 25, 2019

(51) Int. Cl. G06F 3/06; G06F 11/20

(52) U.S. Cl. CPC G06F 3/065; G06F 11/2023; G06F 2201/85; G06F 3/0659; G06F 3/067; G06F 3/0604

(57) ABSTRACT

From a master node within a chain of nodes, a command is sent to form a consistency group. The command causes the chain of nodes to set, at the master node, a first change recording bitmap (CRB) containing a first set of host writes from a host system to an out of synch (OOS) bitmap. A consistent point of data is created across the chain using the OOS bitmap of the master node. At subsequent non-master nodes, the consistent point of data embodied in the OOS bitmap is drained to form the consistency group. During the draining, a second set of host writes is recorded to a second CRB at the master node. In response to a determining the consistency group has been formed, a second command is sent down the chain to reform the consistency group, wherein the second CRB is takes the place of the first CRB.

### BACKGROUND

The present disclosure relates generally to the field of data redundancy, and more particularly to Global Mirror relationships in a chain of nodes.

A mirror relationship may provide for the mirror of one volume to a second volume, a third volume, or to more volumes. A Metro Mirror relationship may provide for a continuous, synchronous mirror of one volume to a second volume, and has a geographic limitation. A traditional Global Mirror relationship also provides for the mirror of one volume to a second volume, but is asynchronous and does not have the geographic limitation of a Metro Mirror relationship.

### SUMMARY

Embodiments of the present disclosure include a method, computer program product, and system for enhanced Global Mirror cascading.

From a master node within a chain of nodes, a command is sent to form a consistency group. The command causes the chain of nodes to set, at the master node, a first change recording bitmap (CRB) containing a first set of host writes from a host system to an out of synch (OOS) bitmap. A consistent point of data is created across the chain using the OOS bitmap of the master node. At subsequent non-master nodes in the chain, the consistent point of data embodied in the OOS bitmap is drained to form the consistency group. During the draining, a second set of host writes is recorded to a second CRB at the master node. In response to a determining the consistency group has been formed, a second command is sent down the chain from the master node to reform the consistency group, wherein the second CRB is takes the place of the first CRB.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a diagram of a traditional chain of nodes, in accordance with embodiments of the present disclosure.

FIG. 2 illustrates a diagram of a chain of nodes using enhanced cascaded Global Mirror relationships, in accordance with embodiments of the present disclosure.

FIG. 3 illustrates a flowchart of a method for Global Mirror consistency group formation, in accordance with embodiments of the present disclosure.

FIG. 4 depicts a cloud computing environment according to an embodiment of the present disclosure.

FIG. 5 depicts abstraction model layers according to an embodiment of the present disclosure.

FIG. 6 illustrates a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of data redundancy, and more particularly to enhanced Global Mirror cascading among a chain of nodes. While the present disclosure is not necessarily limited to such applications, various aspects of the disclosure may be appreciated through a discussion of various examples using this context.

Point-in-time consistency refers to the usability of data, and is particularly important for redundant data (e.g., “backup” data). For example, if the redundant data is not consistent with the production data (e.g., the original, or working data), then data loss will occur when that redundant data is used to restore lost production data. Therefore, preserving consistency between production data and redundant data may be an important goal for disaster recovery systems.

Traditional techniques for data redundancy and disaster recovery may include implementations of Metro Mirror relationships and Global Mirror relationships among storage volumes. Metro Mirror is a copy service capable of providing a continuous and synchronous mirror of one storage volume to another storage volume. Due to the synchronous qualities of the relationship, a user must wait until a write operation has completed at the redundant volume before that data may be accessed. The two volumes can be miles/kilometers apart, but a Metro Mirror relationship is limited geographically—the distance between the volumes cannot exceed approximately 185 miles, or 300 kilometers. Because the Metro Mirror relationship provides a continuous and synchronous mirror, a failure or other disaster event at either storage volume results in no data loss.

Global Mirror is a copy service that is similar to Metro Mirror in that it provides a continuous mirror of one storage volume to a second storage volume, but Global Mirror is asynchronous. Therefore, with a Global Mirror relationship, a user does not need to wait for the write operation to the redundant volume to complete before accessing data at the redundant volume. Additionally, Global Mirror is capable of operating over much longer distances, and therefore provides a strategic advantage over Metro Mirror. For example, certain disaster events (e.g., earthquakes, hurricanes, and other geographically-large disasters) have a much smaller chance of causing a failure at both storage volumes simultaneously, due to the increased distance between the volumes. However, because the Global Mirror relationship is asynchronous, a failure can mean the loss of data (e.g., seconds, or perhaps minutes-worth of data) that has not yet been embodied in the redundant volume.

Certain disaster recovery systems (e.g., IBM's DS8000 ®) can support a variety of cascaded configurations among redundant volumes/systems/nodes. However, cascaded Global Mirror configurations may suffer from data consistency issues.

Embodiments of the present disclosure contemplate disaster recovery systems with enhanced cascading Global Mirror relationships. Enhanced cascading Global Mirror relationships among a chain of redundancy nodes may utilize a consistency group formation to provide data consistency across the chain, speed up recovery time objectives (RTOs), and handle scenarios where multiple systems/nodes in the chain fail. In this way, embodiments of the present disclosure provide a more robust and efficient means for data redundancy and disaster recovery compared to Metro Mirror and traditional Global Mirror relationships.

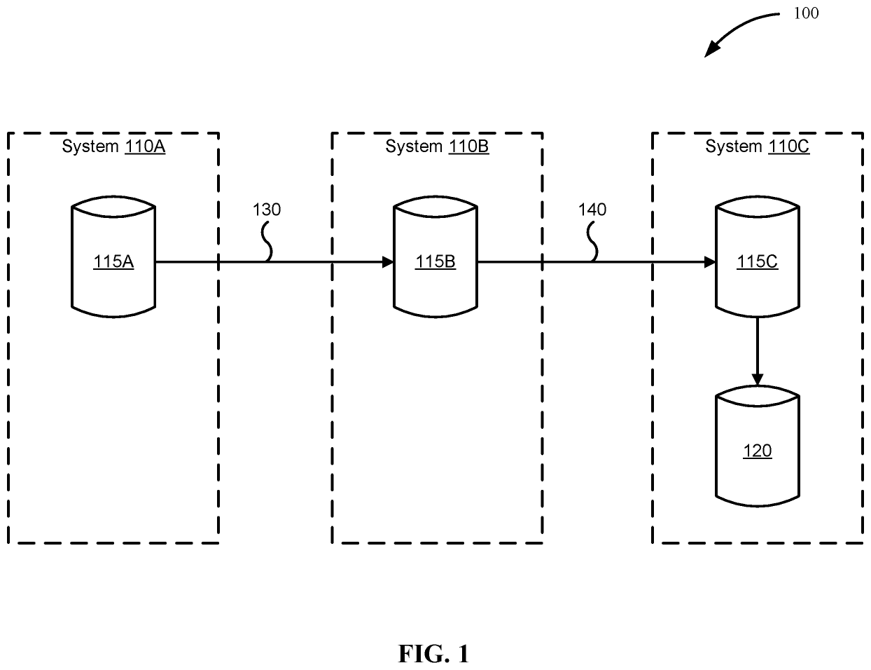

Turning now to the figures, FIG. 1 illustrates a diagram 100 of a traditional chain of nodes, in accordance with embodiments of the present disclosure. Diagram 100 includes systems 110A-110C, with system 110A representing a primary/master node, and system 110B and 110C being non-master nodes along the chain. Read and write operations from a host are directed to system 110A—the master node. System 110A is depicted having a Metro Mirror relationship 130 with system 110B. In other words, the contents of storage volume 115A are continuously and synchronously written to storage volume 115B of system 110B. As described herein, systems 110A and 110B may be separated geographically, but not so far as to impact the synchronous nature of the Metro Mirror relationship 130.

System 110B is depicted having a Global Mirror relationship 140 with system 110C. In other words, the contents of storage volume 115B are continuously and asynchronously stored at system 110C. System 110C may use techniques such as draining data from storage volume 115C to journal volume 120, and journal volume 120 may be used to facilitate disaster recovery operations, if needed. As described herein, systems 110B and 110C may be separated as far apart geographically as desired, due to the Global Mirror relationship 140. In embodiments, draining data may include transferring data using Global Copy.

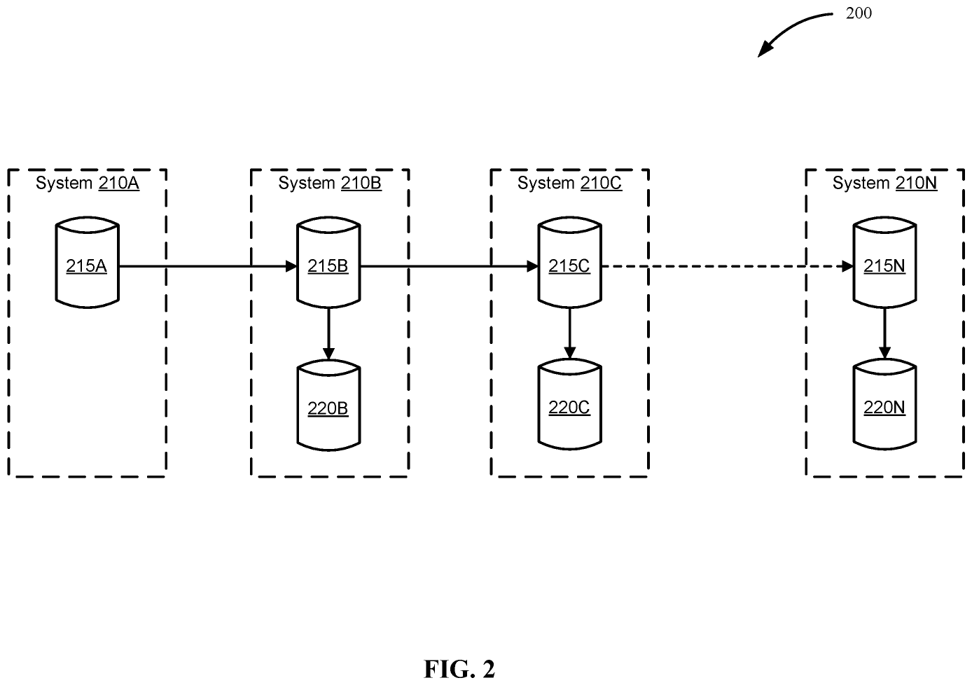

Turning now to FIG. 2, illustrated is a diagram 200 of a chain of nodes using enhanced cascaded Global Mirror relationships, in accordance with embodiments of the present disclosure. It is contemplated that, in practice, systems 210A-N will all have connectivity with each other, the connectivity embodied in a network (depicted only through arrows between storage volumes 215A-215N). It is recognized, however, that in some embodiments interconnectivity among the nodes may be limited, and the chain may be more or less linear and/or branched in nature.

The network may, according to embodiments, be any type or combination of networks. For example, a network may include any combination of personal area network (PAN), local area network (LAN), metropolitan area network (MAN), wide area network (WAN), wireless local area network (WLAN), storage area network (SAN), enterprise private network (EPN), or virtual private network (VPN). In some embodiments, a network may be an IP network, a conventional coaxial-based network, etc. For example, systems 210A-210N may communicate with each other over the Internet.

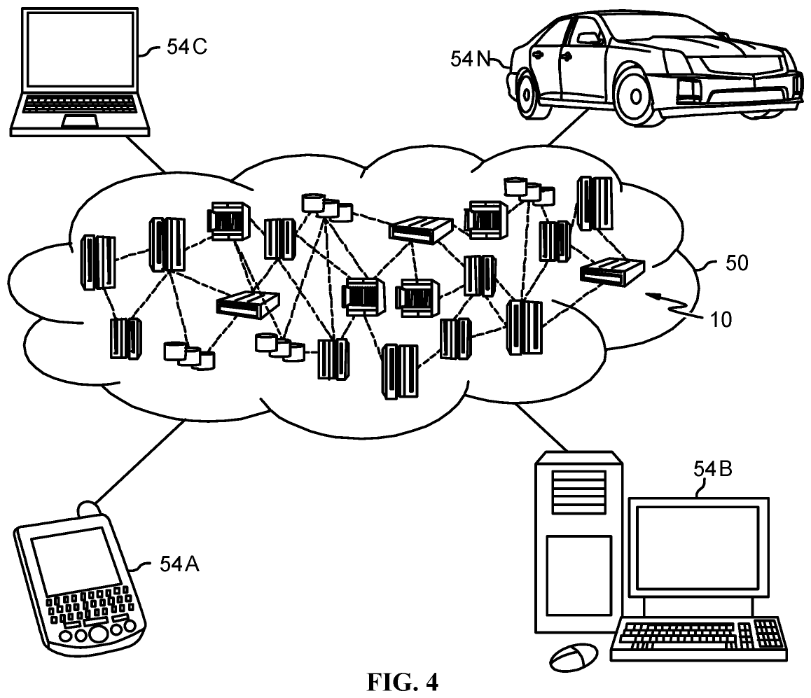

In some embodiments, the network can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources. Cloud computing is discussed in greater detail in regard to FIGS. 4 & 5.

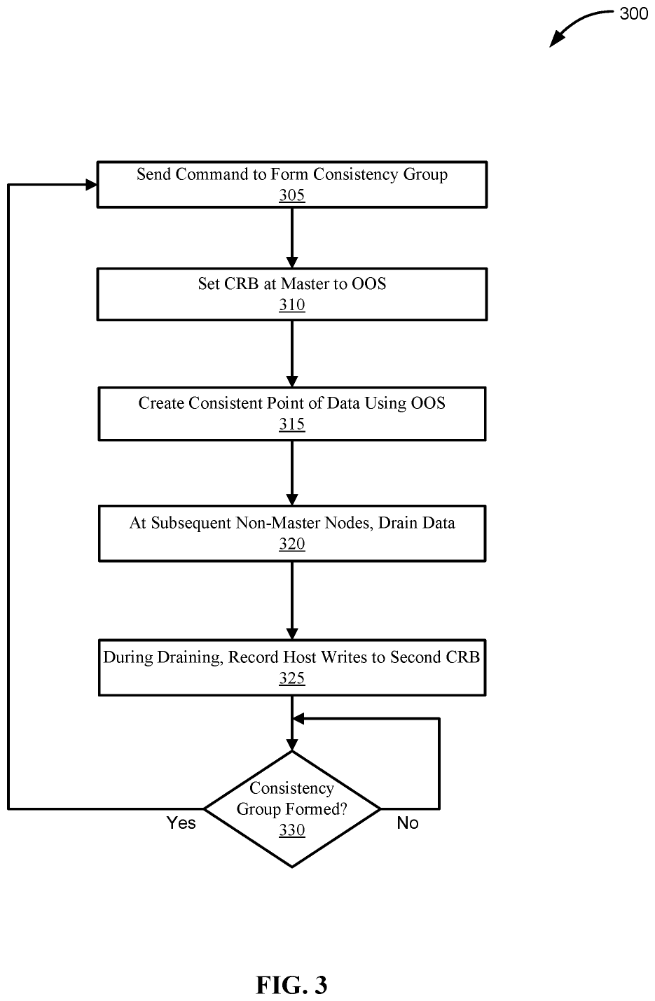

Systems 210A-210N may contain storage volumes 215A-N, respectively, and utilize Global Mirror relationships when backing up data. In embodiments, System 210A may execute a Global Mirror consistency group formation process (e.g., the method described in FIG. 3), and therefore may be referred to as the master node of the chain. Systems 210B-210N may include journal volumes 220B-220N, respectively, for draining data from their respective storage volumes to provide redundant data that may be accessed without regard to whether a host write operation has completed, as discussed herein. Systems 210B-210N may be referred to as secondary or non-master nodes.

In embodiments, the master node, system 210A, may utilize an out of synch (OOS) bitmap to provide a point-in-time copy of data to the secondary systems 210B-210N. While the chain of secondary nodes distributes and processes the OOS bitmap, system 210A may record any changes in the data to a change recording bitmap (CRB). As discussed in greater detail in FIG. 3, the CRB may be used to update the OOS bitmaps for the chain.

Turning now to FIG. 3, illustrated is a flowchart of a method 300 for Global Mirror consistency group formation, in accordance with embodiments of the present disclosure. At 305, the master node (e.g., system 210A of FIG. 2) sends a command down the chain of nodes (e.g., to systems 210B-210N of FIG. 2) to form a consistency group. In embodiments, the master node may be communicatively coupled to a host device, and/or may be the only node within the chain receiving read/write operation data from the host. In embodiments a command sent “down” the chain of nodes may include a sequential distribution (e.g., from a master node, to a first slave node, to a second slave node, etc.), or it may include another distribution scheme (e.g., according to geographic distance, striping according to node performance, striping according to workload distribution, etc.).

To form the consistency group, the master node first sets its CRB, which contains any host writes received, as an OOS bitmap at 310. The OOS bitmap is used to create a consistent point of data across the chain of nodes at 315. This may be achieved, for example, by using a data freeze process to restrict changes to source code or related resources. In embodiments, the OOS bitmap may be used to designate the next node in the chain, and the designation may be updated at each node to designate the subsequent node. For example, the OOS bitmap from system 210A may designate system 210B as its destination, and once the OOS bitmap has been received, a copy thereof may be created with an updated designation of system 210C as its destination, and so on.

At 320, the non-master nodes begin draining data embodied in the OOS bitmap from their respective storage volumes to their respective journal volumes, as described herein, to create a consistency group among the nodes of the chain.

While the non-master nodes are draining, the master node records any host writes to a “second” CRB at 325. In this way, the master node may capture any updates or changes to the data that may occur during the draining process.

At 330, a check is performed to ensure all nodes in the chain contain a consistent point-in-time copy of the data embodied in the OOS bitmap. In other words, it is determined whether the consistency group has been formed. If “No,” then the check may be performed again, and/or remedial measures may be taken (not shown) to ensure a non-responsive node is recovered. In embodiments, a consistent point-in-time copy may include a substantially identical data set among two or more records (e.g., OOS bitmaps).

If “Yes,” then the method 300 may cycle back to 305. However, during this iteration, the new/second CRB is set to the OOS bitmap at the master node. In this way, the cascaded chain of nodes may be enhanced to ensure data consistency among the entire chain while reaping the benefits of Global Mirror relationships, and minimizing the chances for data loss when one or more nodes suffer a disaster/failure, as it is likely at least one node with consistent data will survive.

For example, should a failure occur on any node in the chain that is not the master node (or an attached host system, if the host system is separate from the master node), the chain may continue on all nodes prior to the failure, and the failed node may be recovered and reinserted into the chain. The recovery process may be automated using the data from any of the surviving nodes.

In the event that the master node (or an attached host system, if the host system is separate from the master node) should fail, a manual recovery may be required. A non-master node may be selected as a Manual Recovery System. The host and/or master node may then be directed to the Manual Recovery System, and a normal Global Mirror recovery may be performed. The enhanced cascaded Global Mirror chain may then be reinitiated using the Manual Recovery System as the new master node.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

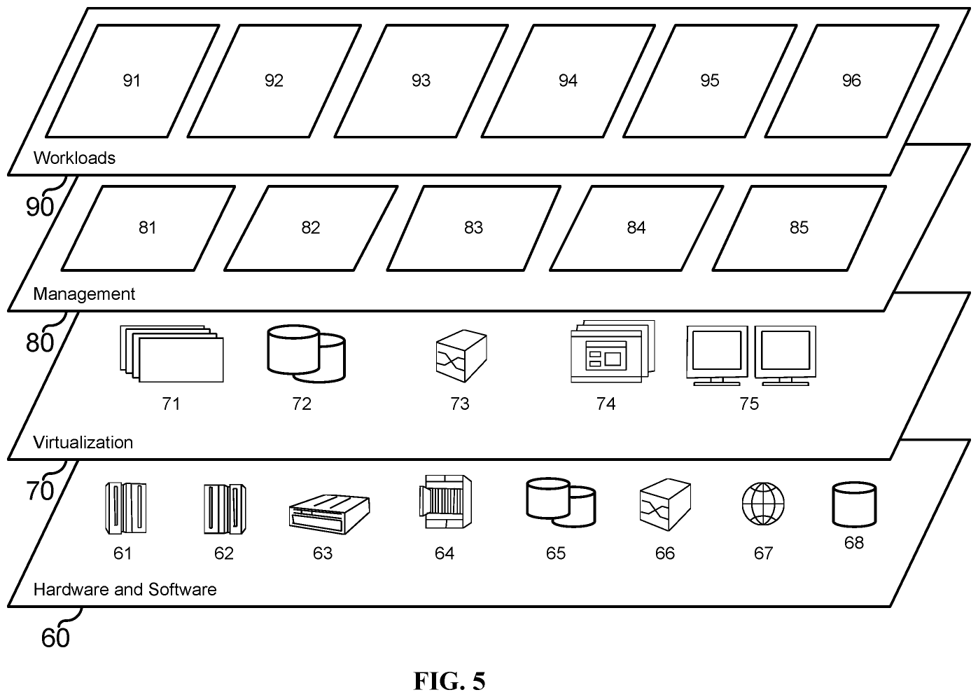

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 5 a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and enhanced Global Mirror cascading 96.

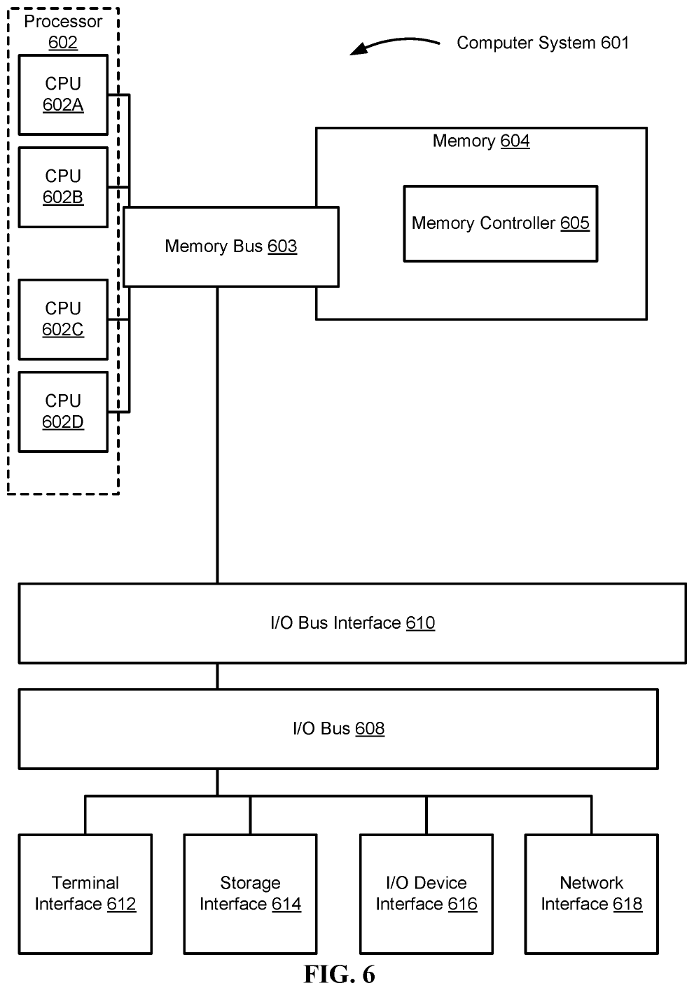

Referring now to FIG. 6, shown is a high-level block diagram of an example computer system 601 that may be configured to perform various aspects of the present disclosure, including, for example, method 300 described in FIG. 3. The example computer system 601 may be used in implementing one or more of the methods or modules, and any related functions or operations, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may comprise one or more levels of on-board cache.

In some embodiments, the memory subsystem 604 may comprise a random-access semiconductor memory, storage device, or storage medium (either volatile or non-volatile) for storing data and programs. In some embodiments, the memory subsystem 604 may represent the entire virtual memory of the computer system 601, and may also include the virtual memory of other computer systems coupled to the computer system 601 or connected via a network. The memory subsystem 604 may be conceptually a single monolithic entity, but, in some embodiments, the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 604 may contain elements for control and flow of memory used by the CPU 602. This may include a memory controller 605.

Although the memory bus 603 is shown in FIG. 6 as a single bus structure providing a direct communication path among the CPUs 602, the memory subsystem 604, and the I/O bus interface 610, the memory bus 603 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for Global Mirror consistency group formation among a chain of nodes, comprising:
sending, from a master node within the chain, a command down the chain of nodes to form a consistency group, the command causing the chain of nodes to:
at the master node, set a first change recording bitmap (CRB), the first CRB containing at least a first set of host writes from a host system, to an out of synch (OOS) bitmap;
create a consistent point of data across the chain using the OOS bitmap from the master node;
drain, at subsequent non-master nodes in the chain, the consistent point of data embodied in the OOS bitmap to form the consistency group;
during the draining, record, at the master node, a second set of host writes to a second CRB;
in response to determining the consistency group has been formed, send, from the master node, a second command down the chain of nodes to reform the consistency group, wherein the second CRB is set to the OOS bitmap.

2. The method of claim 1, wherein creating the consistent point of data is achieved by a data freeze process.

3. The method of claim 2, wherein draining the data embodied in the OOS bitmap includes updating, at each subsequent non-master node of the chain, a local OOS bitmap.

4. The method of claim 3, wherein updating the local OOS bitmap includes designating a subsequent node in the chain.

5. The method of claim 4, wherein the command further causes the chain of nodes to:
determine the master node has failed;
in response to the determination, direct the host system to send subsequent sets of host writes to a non-master recovery node within the chain; and
perform a Global Mirror recovery operation using the non-master recovery node.

6. The method of claim 5, wherein the chain of nodes includes at least one branch.

7. The method of claim 6, wherein the method is executed using DS8000 Copy Services code.

8. A system for Global Mirror consistency group formation among a chain of nodes, comprising:
a memory with program instructions included thereon; and
a processor in communication with the memory, wherein the program instructions cause the processor to:
send, from a master node within the chain, a command down the chain of nodes to form a consistency group, the command causing the chain of nodes to:
at the master node, set a first change recording bitmap (CRB), the first CRB containing at least a first set of host writes from a host system, to an out of synch (OOS) bitmap;
create a consistent point of data across the chain using the OOS bitmap from the master node;
drain, at subsequent non-master nodes in the chain, the consistent point of data embodied in the OOS bitmap to form the consistency group;
during the draining, record, at the master node, a second set of host writes to a second CRB;
in response to determining the consistency group has been formed, send, from the master node, a second command down the chain of nodes to reform the consistency group, wherein the second CRB is set to the OOS bitmap.

9. The system of claim 8, wherein creating the consistent point of data is achieved by a data freeze process.

10. The system of claim 9, wherein draining the data embodied in the OOS bitmap includes updating, at each subsequent non-master node of the chain, a local OOS bitmap.

11. The system of claim 10, wherein updating the local OOS bitmap includes designating a subsequent node in the chain.

12. The system of claim 11, wherein the command further causes the chain of nodes to:
determine the master node has failed;
in response to the determination, direct the host system to send subsequent sets of host writes to a non-master recovery node within the chain; and
perform a Global Mirror recovery operation using the non-master recovery node.

13. The system of claim 12, wherein the chain of nodes includes at least one branch.

14. The system of claim 13, wherein the program instructions are executed using DS8000 Copy Services code.

15. A computer program product for Global Mirror consistency group formation among a chain of nodes, the computer program product comprising a computer readable storage medium having program instructions embodied therewith, the program instructions executable by a device to cause the device to:
send, from a master node within the chain, a command down the chain of nodes to form a consistency group, the command causing the chain of nodes to:
at the master node, set a first change recording bitmap (CRB), the first CRB containing at least a first set of host writes from a host system, to an out of synch (OOS) bitmap;
create a consistent point of data across the chain using the OOS bitmap from the master node;
drain, at subsequent non-master nodes in the chain, the consistent point of data embodied in the OOS bitmap to form the consistency group;
during the draining, record, at the master node, a second set of host writes to a second CRB;
in response to determining the consistency group has been formed, send, from the master node, a second command down the chain of nodes to reform the consistency group, wherein the second CRB is set to the OOS bitmap.

16. The computer program product of claim 15, wherein creating the consistent point of data is achieved by a data freeze process.

17. The computer program product of claim 16, wherein draining the data embodied in the OOS bitmap includes updating, at each subsequent non-master node of the chain, a local OOS bitmap.

18. The computer program product of claim 17, wherein updating the local OOS bitmap includes designating a subsequent node in the chain.

19. The computer program product of claim 18, wherein the command further causes the chain of nodes to:
determine the master node has failed;
in response to the determination, direct the host system to send subsequent sets of host writes to a non-master recovery node within the chain; and
perform a Global Mirror recovery operation using the non-master recovery node.

20. The computer program product of claim 19, wherein the chain of nodes includes at least one branch.
